(19) United States
(12) Patent Application Publication
(10) Pub. No.: US 2024/0403601 A1
(43) Pub. Date: Dec. 5, 2024

(54) METHOD FOR INDUCTIVE KNOWLEDGE GRAPH EMBEDDING USING RELATION GRAPHS AND SYSTEM THEREOF

(71) Applicant: Korea Advanced Institute of Science and Technology, Daejeon (KR)

(72) Inventors: Joyce Jiyoung WHANG, Daejeon (KR); Jaejun LEE, Daejeon (KR); Changyoung CHUNG, Daejeon (KR)

(21) Appl. No.: 18/675,444

(22) Filed: May 28, 2024

(30) Foreign Application Priority Data
May 30, 2023 (KR) 10-2023-0068884
Aug. 17, 2023 (KR) 10-2023-0107688

(51) Int. Cl. G06N 3/042

(52) U.S. Cl. CPC G06N 3/042

(57) ABSTRACT

Disclosed is an inductive knowledge graph embedding method and system through a relation graph. An inductive knowledge graph embedding method performed by a knowledge graph embedding system may include training a graph neural network-based knowledge graph embedding model using a knowledge graph and a relation graph generated from the knowledge graph; and performing link prediction for the knowledge graph that includes a new relation and a new entity through the trained graph neural network-based knowledge graph embedding model.

### BACKGROUND

### 1. Field of the Invention

Example embodiments relate to knowledge graph embedding technology.

### 2. Description of the Related Art

A knowledge graph is a representation of human knowledge in the form of a graph. Each knowledge within a knowledge graph consists of a head entity, a relation, and a tail entity. A knowledge graph embedding method converts each entity and relation within a knowledge graph into a vector. A knowledge graph embedding model performs a task, such as a link prediction, using the generated embedding vector.

Most existing knowledge graph embedding methods assume that all entities and relations are observed in a training stage, so the existing methods have the limitation of being unable to handle a newly emerging entity and relation in an inference stage. To address this limitation, inductive knowledge graph embedding methods to handle a new entity appearing in the inference stage are proposed in some related arts. Corresponding models learn rules between observed relations and apply the learned rules to a new graph or perform link prediction for a new entity through a partial graph structure around the target entity. However, most existing inductive knowledge graph embedding methods are trained with an assumption that all relations within a given knowledge graph are observed. Therefore, most existing inductive knowledge graph embedding methods have the limitation of being unable to handle a newly emerging relation in an inference stage.

### SUMMARY

Example embodiments may provide an inductive knowledge graph embedding method and a system that may handle all newly emerging relations and entities in an inference stage.

According to an aspect, there is provided a method for inductive knowledge graph embedding performed by a knowledge graph embedding system, the method includes training a graph neural network-based knowledge graph embedding model using a knowledge graph and a relation graph generated from the knowledge graph; and performing link prediction for the knowledge graph that includes a new relation and a new entity through the trained graph neural network-based knowledge graph embedding model. The training includes training the graph neural network-based knowledge graph embedding model by repartitioning the knowledge graph into a fact set and a training set at regular intervals through a dynamic split technique, and the graph neural network-based knowledge graph embedding model includes a graph neural network on the relation graph to update the representation vectors that reflect relationship information between relations using the structure of the relation graph and a graph neural network on the knowledge graph to update the representation vectors that reflect connectivity between relations and entities within the knowledge graph using the structure of the knowledge graph.

The training may include generating the relation graph that represents relationships between relations within the knowledge graph from the knowledge graph for training.

The training may include generating a reverse relation for a relation in the knowledge graph, generating a reverse triplet for a triplet in the knowledge graph, and adding the generated reverse relation and the generated reverse triplet to the knowledge graph.

The training may include updating a first representation vector from the generated relation graph through the graph neural network on the relation graph configured in the graph neural network-based knowledge graph embedding model, updating a second representation vector from the knowledge graph through the graph neural network on the knowledge graph configured in the graph neural network-based knowledge graph embedding model, and converting the updated first representation vector and second representation vector to a final embedding vector.

The training may include calculating the first representation vector and the second representation vector through the fact set, calculating a loss for the training set using the calculated embedding vector, and training a weight through optimization of the calculated loss.

The dynamic split technique may extract a portion of the knowledge graph and use the same as the fact set and may use a set of triplets not extracted from the knowledge graph as the training set.

The training may include generating a new feature vector for a relation and a new feature vector for an entity by re-initializing the feature vector of the relation and the feature vector of the entity at regular intervals.

A knowledge graph that includes a new relation and a new entity may be the knowledge graph for inference, and the performing of the link prediction may include generating the relation graph that represents relationships between relations within the knowledge graph for inference.

The performing of the link prediction may include generating a reverse relation for a relation in the knowledge graph, generating a reverse triplet for a triplet in the knowledge graph, and adding the generated reverse relation and the generated reverse triplet to the knowledge graph.

The performing of the link prediction may include updating a first representation vector through the graph neural network on the relation graph configured in the trained graph neural network-based knowledge graph embedding model from the generated relation graph, additionally updating a second representation vector through the graph neural network on the knowledge graph configured in the trained graph neural network-based knowledge graph embedding model from the knowledge graph, and converting the updated first representation vector and second representation vector to the final embedding vectors.

The performing of the link prediction may include calculating a score of a triplet by replacing the empty entity with another entity for an incomplete triplet in which a head entity or a tail entity is empty, and predicting the entity with the highest calculated score as a correct answer.

According to an aspect, there is provided a non-transitory computer-readable recording medium storing instructions that, when executed by a processor, cause the processor to execute an inductive knowledge graph embedding method performed by a knowledge graph embedding system, the inductive knowledge graph embedding method includes training a graph neural network-based knowledge graph embedding model using a knowledge graph and a relation graph generated from the knowledge graph; and performing link prediction for the knowledge graph that includes a new relation and a new entity through the trained graph neural network-based knowledge graph embedding model, the training may include training the graph neural network-based knowledge graph embedding model by repartitioning the knowledge graph into a fact set and a training set at regular intervals through a dynamic split technique, and the graph neural network-based knowledge graph embedding model may include a graph neural network on the relation graph to update the representation vectors that reflect relationship information between relations using the structure of the relation graph and a graph neural network on the knowledge graph to update the representation vectors that reflect connectivity between relations and entities within the knowledge graph using the structure of the knowledge graph.

According to an aspect, there is provided a knowledge graph embedding system including a training unit configured to train a graph neural network-based knowledge graph embedding model using a knowledge graph and a relation graph generated from the knowledge graph; and an inference unit configured to perform link prediction for the knowledge graph that includes a new relation and a new entity through the trained graph neural network-based knowledge graph embedding model. The training unit is configured to train the graph neural network-based knowledge graph embedding model by repartitioning the knowledge graph into a fact set and a training set at regular intervals through a dynamic split technique, and the graph neural network-based knowledge graph embedding model includes a graph neural network on the relation graph to update the representation vectors that reflect relationship information between relations using the structure of the relation graph and a graph neural network on the knowledge graph to update the representation vectors that reflect connectivity between relations and entities within the knowledge graph using the structure of the knowledge graph.

According to some example embodiments, it is possible to generate an embedding vector for a relation and an entity of a given knowledge graph regardless of whether a relation and an entity is observed in a training stage. This may apply to more various scenarios in which a new relation or a new entity appears in an inference stage.

Also, according to some example embodiments, an embedding vector may be generated using only the structure of a knowledge graph and inference may be performed even without the help of a language model that requires massive computing resources or additional information on a newly emerging relation and entity in an inference stage.

According to some example embodiments, it is possible to employ a dynamic split technique and a feature vector re-initialization technique to improve usability in various scenarios through better response to a new knowledge graph and feature vector.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram visualizing various types of inductive inference from a relation perspective on a knowledge graph according to an example embodiment;

FIG. 2 illustrates an inductive knowledge graph embedding operation according to an example embodiment;

FIG. 3 illustrates an operation of generating a relation graph according to an example embodiment;

FIG. 4 is a block diagram illustrating a configuration of a knowledge graph embedding system according to an example embodiment; and

FIG. 5 is a flowchart illustrating an inductive knowledge graph embedding method according to an example embodiment.

### DETAILED DESCRIPTION

Hereinafter, example embodiments will be described with reference to the accompanying drawings.

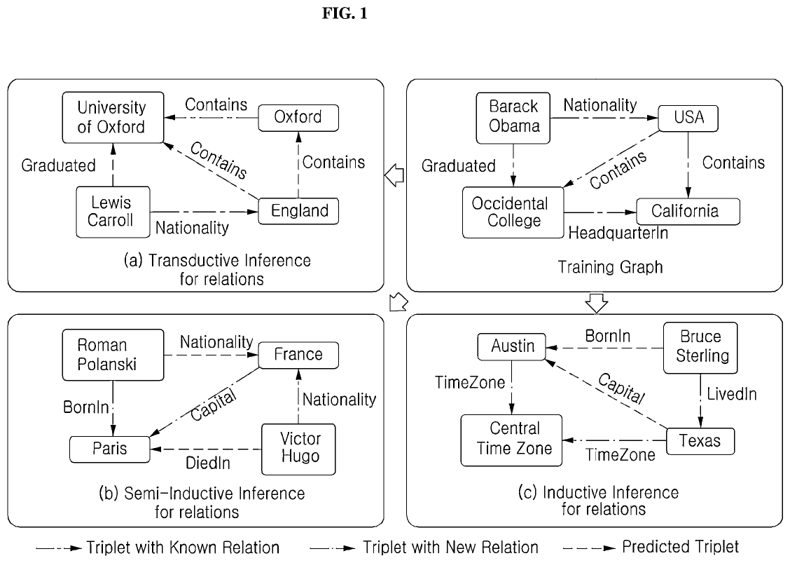

FIG. 1 is a diagram visualizing various types of inductive inference from a relation perspective on a knowledge graph according to an example embodiment.

Most existing inductive knowledge graph embedding methods are designed to focus on a newly emerging entity in an inference stage and do not handle a newly emerging relation well in the inference stage. Some existing inductive knowledge graph embedding methods attempted to infer a case in which a new relation appears in the inference stage through introduction of a language model. However, corresponding methods have an issue that inference is impossible without help of the language model that requires massive computing resources, or that inference is impossible when explanatory information on a new relation is not given.

To address the issue found in most existing inductive knowledge graph embedding methods, an example embodiment may provide an inductive knowledge graph embedding method and a system that may handle all newly emerging relations and entities in an inference stage. According to an example embodiment, it is possible to generate an embedding vector using only the structure of a knowledge graph and it is possible to perform inference even without help of a language model that requires massive computing resources or additional information on a new relation and entity.

Most existing inductive knowledge graph embedding methods may perform inference only when all relations are observed in a training stage as shown in (a) of FIG. 1. The inductive knowledge graph embedding method proposed in an example embodiment may perform inference in a case in which some relations newly appear in an inference stage as shown in (b) of FIG. 1 and in a case in which all relations newly appear in the inference stage as shown in (c) of FIG. 1, in addition to a case in which some or all entities may newly emerge in the inference stage. The inductive knowledge graph embedding method proposed in an example embodiment may promote usability of knowledge graph embedding by enabling inference in more various scenarios than in the art.

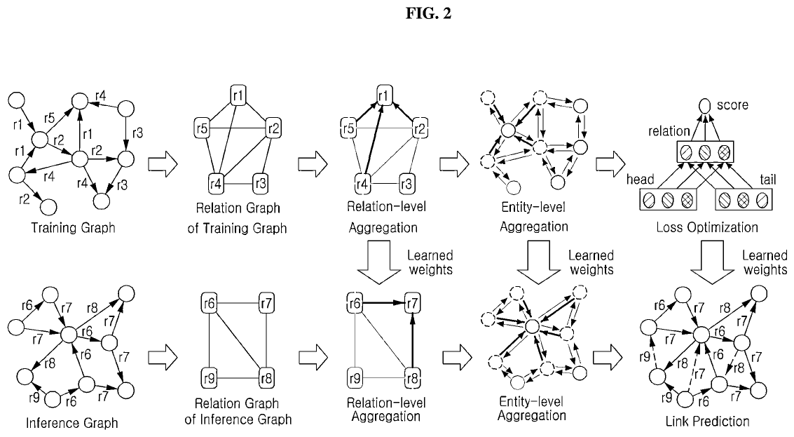

FIG. 2 illustrates an inductive knowledge graph embedding operation according to an example embodiment.

A knowledge graph embedding method may include a training stage and an inference stage for inductive knowledge graph embedding. The top of FIG. 2 visualizes a training stage, and the bottom of FIG. 2 visualizes an inference stage. A knowledge graph embedding system may generate a relation graph that represents the relationships between relations for a given knowledge graph. The knowledge graph embedding system may input the generated relation graph to a graph neural network-based knowledge graph embedding model. Here, the graph neural network-based knowledge graph embedding model may include a graph neural network on the relation graph and a graph neural network on the knowledge graph. The knowledge graph embedding system may calculate relation and entity embedding vectors in the knowledge graph through the graph neural network-based knowledge graph embedding model. In the training stage, the graph neural network-based knowledge graph embedding model may learn a weight capable of better responding to a new knowledge graph through a dynamic split technique and a feature vector re-initialization technique. Finally, the graph neural network-based knowledge graph embedding model may learn a model weight to increase the score of a triplet within a training set by optimizing a loss through an optimization technique.

In the inference stage, the knowledge graph embedding system may perform link prediction for a knowledge graph that includes new relations and entities through the trained graph neural network-based knowledge graph embedding model. The knowledge graph embedding system may generate the relation graph from the knowledge graph that includes new relations and entities. The knowledge graph embedding system may calculate an embedding vector of a relation and an embedding vector of an entity in the knowledge graph using the weight learned through the graph neural network-based knowledge graph embedding model and may perform a task, such as link prediction, using the calculated embedding vector of the relation and embedding vector of the entity.

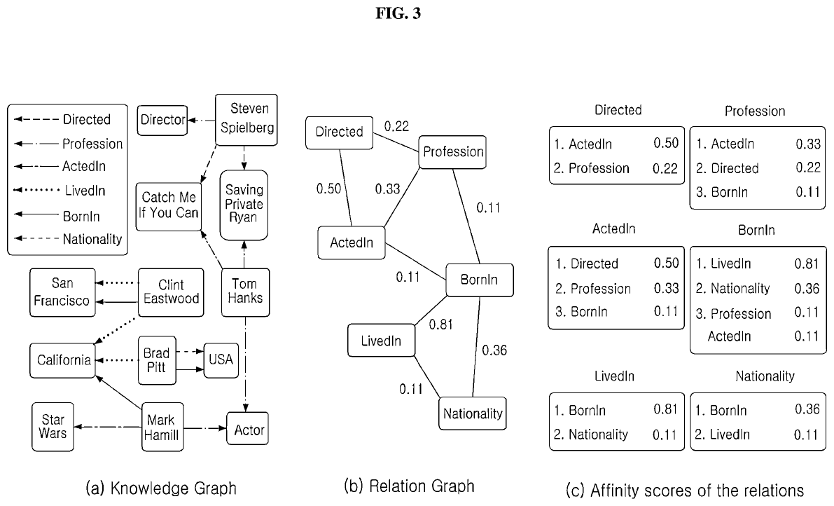

FIG. 3 illustrates an operation of generating a relation graph according to an example embodiment.

A knowledge graph embedding system may generate a relation graph that models the relationships between relations based on a given knowledge graph and may use the generated relation graph for training and inference. The relationships between relations may be modeled from various perspectives and an example embodiment is described based on an example of modeling the relationships between relations through structural affinity.

When a knowledge graph is given, the knowledge graph embedding system may add a reverse relation for each relation and a reverse triplet for each triplet to the knowledge graph, to reflect more diverse relationships between relations in the graph neural network-based knowledge graph embedding model. Specifically, the knowledge graph embedding system may add a reverse relation r⁻¹ for a given relation r to the knowledge graph. Also, the knowledge graph embedding system may generate a reverse triplet (t, r⁻¹, h) for a given triplet (h, r, t) and add the same to the knowledge graph.

Using the knowledge graph that includes m relations and n entities generated through the above process, two matrices Eₕ∈ [symbol] and Eₜ∈ [symbol] that represent associations between relations and entities may be defined. Here, Eₕ[i,j] is the number of times the i-th entity appears as a head entity of the j-th relation, and Eₜ[i,j] is the number of times the i-th entity appears as a tail entity of the j-th relation.

Two matrices Aₕ and Aₜ may be defined to represent an overlapping level of a head entity or a tail entity between relations. When Dₕ represents a diagonal matrix that satisfies Dₕ[i,i]=ΣⱼEₕ[i,j], it may be defined as Aₕ=Eₕ^{T}Dₕ^{-k}Eₕ. Likewise, when Dₜ represents a diagonal matrix that satisfies Dₜ[i,i]=ΣⱼEₜ[i,j], it may be defined as Aₜ=Eₜ^{T}Dₜ^{-k}Eₜ. Here, k may be a hyperparameter of the knowledge graph embedding system and an arbitrary value may be used.

Finally, an adjacency matrix of the relation graph may be defined as A=Aₕ+Aₜ. Here, A[i,j] represents structural affinity between the i-th relation and the j-th relation. In addition to the above example, the knowledge graph embedding system may generate the relation graph in a similar manner as above using an arbitrary method of modeling relationships between relations.

(a) of FIG. 3 visualizes a knowledge graph and (b) of FIG. 3 visualizes a relation graph generated from the knowledge graph. (c) of FIG. 3 shows structural affinities between relations in the generated relation graph. For simplicity, a reverse relation and a self-loop are not visualized. In a given example, it can be seen that the structural affinities between relations that share a lot of head and tail entities, such as ‘LivedIn’ and ‘BornIn,’ are calculated high. Therefore, it can be seen that the generated relation graph models the relationships by calculating the affinities between relations through applying of a structural characteristic of the given knowledge graph.

Referring again to FIG. 2, in more detail, the knowledge graph embedding system may calculate an embedding vector of a relation and an embedding vector of an entity through the graph neural network on the relation graph and the graph neural network on the knowledge graph configured in the graph neural network-based knowledge graph embedding model. The knowledge graph embedding system may generate an embedding vector that considers all relationships between relations and relationships between entities. The graph neural network on the relation graph and the graph neural network on the knowledge graph may be sequentially used or repeatedly used, depending on the usage. One or more graph neural networks may not be used.

The purpose of the graph neural network on the relation graph is to update a representation vector using the structure of the relation graph. Specifically, the knowledge graph embedding system may calculate the representation vectors that reflect relationship information between relations through the graph neural network on the relation graph configured in the graph neural network-based knowledge graph embedding model. Hereinafter, the graph neural network on the relation graph is described using an example.

When a feature vector xᵢ of the i-th relation is given, an initial representation vector zᵢ⁽⁰⁾=Hxᵢ of the relation may be calculated using the corresponding feature vector. Here, H represents a learnable matrix that converts a feature vector of a relation to an initial representation vector. A method of converting the feature vector of the relation to the representation vector is not limited to the aforementioned method.

When a representation vector of the i-th relation at the l-th layer is defined as zᵢ^{(l)}, each layer of the graph neural network on the relation graph may be expressed as follows.

$${z}_{i}^{( l + 1 )} = σ ( {\sum }_{{r}_{j} ∈ {𝒩}_{i}} {α}_{ij}^{( l )} {W}^{( l )} {z}_{j}^{( l )} ) \qquad Equation 1$$

Here, σ denotes an activation function, [symbol] denotes a set of neighboring relations of the i-th relation on the relation graph, aᵢⱼ^{(l)} denotes a weight of the j-th relation for the i-th relation at the 1-th layer, and w^{(l)} denotes a weight matrix at the l-th layer. ReLU and the like may be used for the activation function, but the present disclosure is not limited thereto.

The weight aᵢⱼ^{(l)} of the j-th relation for the i-th relation may be calculated as follows.

$${α}_{ij}^{( l )} = \frac{exp ( {y}^{( l )} σ ( {P}^{( l )} [ \text{?} \vert \vert {z}_{j}^{( l )} ] ) + {c}_{s ( i , j )}^{( l )} )}{{\sum }_{{r}_{{j}^{′}} ∈ {𝒩}_{i}} exp ( {y}^{( l )} σ ( {P}^{( l )} [ {z}_{i}^{( l )} \vert \vert {z}_{{j}^{′}}^{( l )} ] ) + {c}_{s ( i , {j}^{′} )}^{( l )} )} \qquad Equation 2$$

$$\text{?} \text{indicates text missing or illegible when filed}$$

Here, ∥ denotes concatenation of vectors, y^{(l)} and P^{(l)} denote an attention vector and an attention matrix at the l-th layer, respectively, c_{s(i,j)}^{(l)} and denotes a model parameter at the l-th layer according to relationship between the i-th relation and the j-th relation on the relation graph. The graph neural network-based knowledge graph embedding model may learn c_{s(i,j)}^{(l)} to have a different value according to the relationships on the relation graph through the graph neural network on the relation graph. The implementation of index s (i, j) that identifies c_{s(i,j)}^{(l)} may be different depending on an usage example, but an example is as follows.

$$s ( i , j ) = ⌈ \frac{rank ( {a}_{ij} ) \times B}{nnz ( A )} ⌉ \qquad Equation 3$$

Here, aᵢⱼ denotes the weight of an edge between the i-th relation and the j-th relation on the relation graph, rank(aᵢⱼ) denotes the rank of aᵢⱼ when weights of edges in the relation graph are listed in descending order, B denotes the total number of indices, and nnz(A) denotes the number of edges in the relation graph.

The graph neural network on the relation graph may be expanded using multi-head attention and the like, and an additional technique, such as residual connection, may be used. The above example is only an example of a method of implementing the graph neural network on the relation graph and the method proposed in an example embodiment is not limited thereto.

The purpose of the graph neural network on the knowledge graph is to update the representation vectors using the structure of the given knowledge graph. Specifically, the knowledge graph embedding system may calculate the representation vectors that reflect connectivity between relations and entities in the knowledge graph through the graph neural network on the knowledge graph configured in the graph neural network-based knowledge graph embedding model. Hereinafter, the graph neural network on the knowledge graph is described using an example.

When a feature vector \hat{x}ᵢ of the i-th entity is given, an initial representation vector hᵢ⁽⁰⁾=Ĥ\hat{x}ᵢ of the entity may be calculated using the corresponding feature vector. Here, Ĥ represents a learnable matrix that converts the feature vector of an entity to an initial representation vector. A method of converting a feature vector of an entity to a representation vector is not limited to the aforementioned method.

When a representation vector of the i-th entity at the 1-th layer is defined as hᵢ^{(l)}, each layer of the graph neural network on the knowledge graph may be expressed as follows.

### Equation 4:

$${h}_{i}^{( l + 1 )} = σ ( \text{?} {( l )}^{} [ \text{?} ‖ {\overline{z}}_{i}^{( L )} ] + {\sum }_{{v}_{j} ∈ {i}_{}} {\sum }_{{r}_{k} ∈ {ℛ}_{ji}} \text{?} {( l )}^{} [ {h}_{j}^{( l )} \vert \vert {z}_{k}^{( L )} ] )$$

$$\text{?} \text{indicates text missing or illegible when filed}$$

Here, βᵢᵢ^{(l)} denotes the weight for the i-th entity itself in the l-th layer, βᵢⱼₖ^{(l)} denotes the weight of a triplet (j-th entity, k-th relation, i-th entity) for the i-th entity at the l-th layer, ŵ^{(l)} denotes a weight matrix at the l-th layer, z̅ᵢ^{(L)} denotes a representation vector of a self-loop for the i-th entity, [symbol] denotes a set of neighboring entities of the i-th entity on the knowledge graph, and [symbol] denotes a set of relations belonging to a triplet in which the head entity is the j-th entity and the tail entity is the i-th entity.

The representation vector z̅ᵢ^{(L)} of the self-loop for the i-th entity is used to acquire a weight for itself and may be defined as follows.

$${\overline{z}}_{i}^{( L )} = {\sum }_{{v}_{j} ∈ {i}_{}} {\sum }_{{r}_{k} ∈ {ℛ}_{ji}} \frac{{z}_{k}^{( L )}}{\text{?} \vert {ℛ}_{{j}^{′} i} \vert} \qquad Equation 5$$

$$\text{?} \text{indicates text missing or illegible when filed}$$

The, weights and i may be defined as follows.

$$\text{?} = \frac{exp ( \text{?} σ ( \text{?} ) )}{exp ( \text{?} σ ( \text{?} ) ) + \text{?} exp ( \text{?} σ ( \text{?} ) )} \qquad Equation 6$$

$$\text{?} = \frac{exp ( \text{?} σ ( \text{?} ) )}{exp ( \text{?} σ ( \text{?} ) ) + \text{?} exp ( \text{?} σ ( \text{?} ) )}$$

$$\text{?} \text{indicates text missing or illegible when filed}$$

Here, ŷ^{(l)} and \hat{P}^{(l)} denote an attention vector and an attention matrix at the l-th layer, respectively, and bᵢᵢ^{(l)} and Bᵢⱼₖ^{(l)} may be defined as follows.

$${b}_{ii}^{( l )} = [ {h}_{i}^{( l )} ‖ {h}_{i}^{( l )} ‖ {\overline{z}}_{i}^{( L )} ] \qquad Equation 8$$

$${b}_{ijk}^{( l )} = [ {h}_{i}^{( l )} ‖ {h}_{j}^{( l )} ‖ {z}_{k}^{( L )} ] \qquad Equation 9$$

The graph neural network on the knowledge graph may be expanded using multi-head attention and the like, and an additional technique, such as residual connection, may be used. The above example is only an example of a method of implementing the graph neural network on the knowledge graph and the method proposed in an example embodiment is not limited thereto.

The knowledge graph embedding system may convert, to the final embedding vectors, the representation vectors of the relations and the representation vectors of entities acquired through the graph neural network on the relation graph and the graph neural network on the knowledge graph configured in the graph neural network-based knowledge graph embedding model.

An embedding vector zₖ for the k-th relation is calculated as Zₖ=Mzₖ^{(l)}. Here, M represents a learnable matrix that converts a representation vector of a relation to an embedding vector. Also, an embedding vector hᵢ for the i-th entity is calculated as hᵢ=\hat{M}hᵢ^{(L)}. Here, \hat{M} represents a learnable matrix that converts a representation vector of an entity to an embedding vector. A method of converting representation vectors of relations and entities to embedding vectors is not limited to the aforementioned method.

The knowledge graph embedding system may learn weights using a fact set and a training set through the graph neural network-based knowledge graph embedding model. Initially, the knowledge graph embedding system may calculate the embedding vector of a relation and the embedding vector of an entity through the graph neural network-based knowledge graph embedding model using the fact set. Then, the knowledge graph embedding system may calculate a loss for the training set using the embedding vectors calculated through the graph neural network-based knowledge graph embedding model and may train the graph neural network-based knowledge graph embedding model by optimizing the calculated loss. In an example embodiment, proposed is a dynamic split technique and a feature vector re-initialization technique that are techniques that allow the graph neural network-based knowledge graph embedding model to better respond to various graph structures appearing in an inference stage.

The dynamic split technique refers to a method of repartitioning a given knowledge graph and thereby using different fact sets and training sets at regular intervals. Specifically, the graph neural network-based knowledge graph embedding model may extract a portion of the given knowledge graph and use the same as the fact set and may use an unextracted triplet as the training set at regular intervals. An interval for performing dynamic split may be every training epoch, but is not limited thereto. Through this, the graph neural network-based knowledge graph embedding model may proceed with training using fact sets in various structures.

Hereinafter, an example of the dynamic split technique is described. Initially, the knowledge graph embedding system may extract a minimum spanning tree from the knowledge graph, may randomly select a relation label, and may define the same as a fact set. Then, for each relation not included in the minimum spanning tree in which relations are reflected, the knowledge graph embedding system may randomly extract a triplet including the corresponding relation from the knowledge graph and may add the extracted triplet to the fact set. Finally, the knowledge graph embedding system may add a triplet that is included in the knowledge graph but is not included in the fact set to the fact set until the fact set reaches a certain size. The knowledge graph embedding system may use a triplet not extracted from the knowledge graph as the training set. Through this process, the knowledge graph embedding system may train the graph neural network-based knowledge graph embedding model by generating a new fact set and a new training set at regular intervals. The above method is an example of the dynamic split technique and the technique proposed in the example embodiment is not limited thereto.

The knowledge graph embedding system may randomly re-initialize feature vectors of a relation and an entity at regular intervals. Specifically, the knowledge graph embedding system may generate a new feature vector of the relation and a new feature vector of the entity using Glorot initialization at regular intervals. An interval for performing feature vector initialization may be every training epoch, but the present disclosure is not limited thereto. The graph neural network-based knowledge graph embedding model may be trained to better respond to new feature vectors of relations and entities that appear in an inference stage through the feature vector re-initialization technique. In addition to the Glorot initialization technique, various initialization techniques may be used.

The dynamic split technique and the feature vector re-initialization technique may be used depending on a usage example and one or more techniques may not be used.

The loss may be defined to learn the inductive knowledge graph embedding method proposed in an example embodiment. During training, the graph neural network-based knowledge graph embedding model may update the weights by optimizing the loss through an optimization technique.

An example of the loss is as follows.

$$L = \text{?} max ( 0 , γ - f ( {v}_{i} , {r}_{k} , {v}_{j} ) + f ( \text{?} , {r}_{k} , \text{?} ) ) \qquad Equation 10$$

$$\text{?} \text{indicates text missing or illegible when filed}$$

Here, ε denotes a training set, \dot{ε} denotes a corrupted training set, γ denotes a margin, and f denotes a scoring function that receives a triplet (h, r, t) as input. Each corrupted triplet in the corrupted training set may be generated by replacing a head entity or a tail entity of each triplet with a random entity. The loss may be implemented in various forms in addition to the above form.

The knowledge graph embedding system may generate an embedding vector of a relation and an embedding vector of an entity in an inference stage through an inductive knowledge graph embedding method. Initially, the knowledge graph embedding system may generate a relation graph using a knowledge graph given in the inference stage. Here, the knowledge graph embedding system may generate a reverse relation for the relation in the knowledge graph, may generate a reverse triplet for a triplet in the knowledge graph, and may add the generated reverse relation and the generated reverse triplet to the knowledge graph. Then, through the trained graph neural network on the relation graph and graph neural network on the knowledge graph, an embedding vector of the relation and an embedding vector of the entity may be calculated. Through this, the graph neural network-based knowledge graph embedding model may calculate the embedding vectors regardless of whether the relation and the entity are observed.

The calculated embedding vectors may be used for various tasks, such as link prediction. The link prediction is an inference task that predicts an empty entity for an incomplete triplet in which a head entity or a tail entity is empty. For a given incomplete triplet (h, r, ?) or (?, r, t), the knowledge graph embedding system may calculate the score of the corresponding triplet by replacing an empty entity with each entity through the trained graph neural network-based knowledge graph embedding model and then may predict the entity with the highest score as a correct answer. The calculated embedding vectors may be used for a task, such as a relation prediction and a triplet classification, in addition to the link prediction. The usage range is not limited thereto.

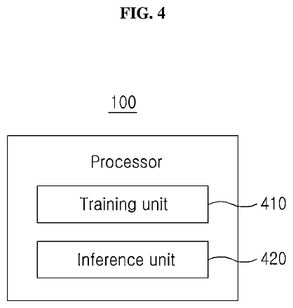

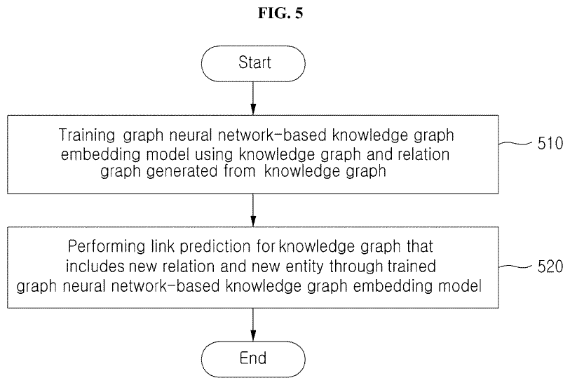

FIG. 4 is a block diagram illustrating a configuration of a knowledge graph embedding system according to an example embodiment, and FIG. 5 is a flowchart illustrating an inductive knowledge graph embedding method according to an example embodiment.

A processor of a knowledge graph embedding system 100 may include a training unit 410 and an inference unit 420. Components of the processor may be representations of different functions that are performed by the processor in response to a control command provided from a program code stored in the knowledge graph embedding system 100. The processor and components of the processor may control the knowledge graph embedding system 100 to perform operations 510 and 520 included in the inductive knowledge graph embedding method of FIG. 5. Here, the processor and the components of the processor may be implemented to execute an instruction according to a code of at least one program and a code of an operating system (OS) included in a memory.

The processor may load, to the memory, a program code stored in a file of a program for the inductive knowledge graph embedding method. For example, when the program runs on the knowledge graph embedding system 100, the processor may control the knowledge graph embedding system 100 to load the program code from the file of the program to the memory under control of the OS. Here, the training unit 410 and the inference unit 420 may be different functional representations of the processor to perform operations 510 and 510, respectively, by executing an instruction of a corresponding portion in the program code loaded to the memory.

In operation 510, the training unit 410 may train a graph neural network-based knowledge graph embedding model using a knowledge graph and a relation graph generated from the knowledge graph. Here, the graph neural network-based knowledge graph embedding model may include a graph neural network on the relation graph to update representation vectors that reflect relationship information between relations using the structure of the relation graph and a graph neural network on the knowledge graph to update representation vectors that reflect connectivity between relations and entities within the knowledge graph using the structure of the knowledge graph. The training unit 410 may generate the relation graph representing relationships between relations within the knowledge graph for training. The training unit 410 may generate a reverse relation for a relation in the knowledge graph, may generate a reverse triplet for a triplet in the knowledge graph, and may add the generated reverse relation and the generated reverse triplet to the knowledge graph. The training unit 410 may update a first representation vector from the generated relation graph through the graph neural network on the relation graph configured in the graph neural network-based knowledge graph embedding model, may update a second representation vector from the knowledge graph through the graph neural network on the knowledge graph configured in the graph neural network-based knowledge graph embedding model, and may convert the updated first representation vector and second representation vector to a final embedding vector. The training unit 410 may calculate the first representation vector and the second representation vector through a fact set, may calculate a loss for a training set using the calculated embedding vector, and may learn weights through optimization of the calculated loss. The training unit 410 may train the graph neural network-based knowledge graph embedding model by repartitioning the knowledge graph into the fact set and the training set at regular intervals through a dynamic split technique. Here, the dynamic split technique may extract a portion of the knowledge graph and use the same as the fact set and may use a set of triplets not extracted from the knowledge graph as the training set. The training unit 410 may generate a new feature vector for the relation and a new feature vector for the entity by re-initializing the feature vectors of the relations and the feature vectors of the entities at regular intervals.

In operation 520, the inference unit 420 may perform link prediction for the knowledge graph that includes a new relation and a new entity through the trained graph neural network-based knowledge graph embedding model. The inference unit 420 may generate the relation graph that represents relationships between relations within the knowledge graph for inference. The inference unit 420 may generate a reverse relation for a relation in the knowledge graph, may generate a reverse triplet for a triplet in the knowledge graph, and may add the generated reverse relation and the generated reverse triplet to the knowledge graph. The inference unit 420 may update a first representation vector through the graph neural network on the relation graph configured in the trained graph neural network-based knowledge graph embedding model from the generated relation graph, may additionally update a second representation vector through the graph neural network on the knowledge graph configured in the trained graph neural network-based knowledge graph embedding model from the knowledge, and may convert the updated first representation vector and second representation vector to the final embedding vectors. The inference unit 420 may calculate a score of a triplet by replacing an empty entity with another entity for an incomplete triplet in which a head entity or a tail entity is empty, and may predict the entity with the highest calculated score as a correct answer.

The apparatuses described herein may be implemented using hardware components, software components, and/or combination of the hardware components and the software components. For example, a processing device and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or at least one combination thereof, for independently or collectively instructing or configuring the processing device to operate as desired. Software and/or data may be embodied in any type of machine, component, physical equipment, virtual equipment, computer storage medium or device, to provide instructions or data to the processing device or be interpreted by the processing device. The software also may be distributed over network coupled computer systems so that the software is stored and executed in a distributed fashion. The software and data may be stored in one or more computer readable storage mediums.

The methods according to example embodiments may be implemented in the form of a program instruction executable through various computer methods and recorded in non-transitory computer-readable media. The media may include, alone or in combination with program instructions, a data file, a data structure, and the like. The program instructions recorded in the media may be specially designed and configured for the example embodiments or may be known to those skilled in the computer software art and thereby available. Examples of the media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of program instructions include a machine code as produced by a compiler and an advanced language code executable by a computer using an interpreter.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents. In addition, the singular includes the plural unless otherwise stated, and the plural includes the singular unless otherwise stated.

Therefore, other implementations, other example embodiments, and equivalents of the claims are to be construed as being included in the claims.

What is claimed is:

1. A method for inductive knowledge graph embedding performed by a knowledge graph embedding system, the method comprising:
training a graph neural network-based knowledge graph embedding model using a knowledge graph and a relation graph generated from the knowledge graph; and
performing link prediction for the knowledge graph that includes a new relation and a new entity through the trained graph neural network-based knowledge graph embedding model,
wherein the training comprises training the graph neural network-based knowledge graph embedding model by repartitioning the knowledge graph into a fact set and a training set at regular intervals through a dynamic split technique, and
the graph neural network-based knowledge graph embedding model includes a graph neural network on the relation graph to update representation vectors that reflect relationship information between relations using the structure of the relation graph and a graph neural network on the knowledge graph to update representation vectors that reflect connectivity between relations and entities within the knowledge graph using the structure of the knowledge graph.

2. The method of claim 1, wherein the training comprises generating the relation graph that represents relationships between relations within the knowledge graph from the knowledge graph for training.

3. The method of claim 2, wherein the training comprises generating a reverse relation for a relation in the knowledge graph, generating a reverse triplet for a triplet in the knowledge graph, and adding the generated reverse relation and the generated reverse triplet to the knowledge graph.

4. The method of claim 1, wherein the training comprises updating a first representation vector from the generated relation graph through the graph neural network on the relation graph configured in the graph neural network-based knowledge graph embedding model, updating a second representation vector from the knowledge graph through the graph neural network on the knowledge graph configured in the graph neural network-based knowledge graph embedding model, and converting the updated first representation vector and second representation vector to the final embedding vectors.

5. The method of claim 4, wherein the training comprises calculating the first representation vector and the second representation vector through the fact set, calculating a loss for the training set using the calculated embedding vector, and training weights through optimization of the calculated loss.

6. The method of claim 1, wherein the dynamic split technique extracts a portion of the knowledge graph and uses the same as the fact set and uses a set of triplets not extracted from the knowledge graph as the training set.

7. The method of claim 1, wherein the training comprises generating a new feature vector for a relation and a new feature vector for an entity by re-initializing a feature vector of the relation and a feature vector of the entity at regular intervals.

8. The method of claim 1, wherein the knowledge graph that includes a new relation and a new entity is the knowledge graph for inference, and
the performing of the link prediction comprises generating the relation graph that represents relationships between relations within the knowledge graph from the knowledge graph for inference.

9. The method of claim 8, wherein the performing of the link prediction comprises generating a reverse relation for a relation in the knowledge graph, generating a reverse triplet for a triplet in the knowledge graph, and adding the generated reverse relation and the generated reverse triplet to the knowledge graph.

10. The method of claim 1, wherein the performing of the link prediction comprises updating a first representation vector through the graph neural network on the relation graph configured in the trained graph neural network-based knowledge graph embedding model from the generated relation graph, additionally updating a second representation vector through the graph neural network on the knowledge graph configured in the trained graph neural network-based knowledge graph embedding model from the knowledge graph, and converting the updated first representation vector and second representation vector to the final embedding vectors.

11. The method of claim 1, wherein the performing of the link prediction comprises calculating score of a triplet by replacing an empty entity with another entity for an incomplete triplet in which a head entity or a tail entity is empty, and predicting the entity with the highest calculated score as a correct answer.

12. A non-transitory computer-readable recording medium storing instructions that, when executed by a processor, cause the processor to execute an inductive knowledge graph embedding method performed by a knowledge graph embedding system, the inductive knowledge graph embedding method comprising:
training a graph neural network-based knowledge graph embedding model using a knowledge graph and a relation graph generated from the knowledge graph; and
performing link prediction for the knowledge graph that includes a new relation and a new entity through the trained graph neural network-based knowledge graph embedding model,
the training comprises training the graph neural network-based knowledge graph embedding model by repartitioning the knowledge graph into a fact set and a training set at regular intervals through a dynamic split technique, and
the graph neural network-based knowledge graph embedding model includes a graph neural network on the relation graph to update representation vectors that reflect relationship information between relations using the structure of the relation graph and a graph neural network on the knowledge graph to update representation vectors that reflect connectivity between relations and entities within the knowledge graph using the structure of the knowledge graph.

13. A knowledge graph embedding system comprising:
a training unit configured to train a graph neural network-based knowledge graph embedding model using a knowledge graph and a relation graph generated from the knowledge graph; and
an inference unit configured to perform link prediction for the knowledge graph that includes a new relation and a new entity through the trained graph neural network-based knowledge graph embedding model,
wherein the training unit is configured to train the graph neural network-based knowledge graph embedding model by repartitioning a knowledge graph into a fact set and a training set at regular intervals through a dynamic split technique, and
the graph neural network-based knowledge graph embedding model includes a graph neural network on the relation graph to update representation vectors that reflect relationship information between relations using the structure of the relation graph and a graph neural network on the knowledge graph to update representation vectors that reflect connectivity between relations and entities within the knowledge graph using the structure of the knowledge graph.
